(19) United States
(12) Patent Application Publication
(10) Pub. No.: US 2005/0259189 A1
(43) Pub. Date: Nov. 24, 2005

(54) Low modulus substrate for flexible flat panel display

(75) Inventors: Petrus Cornelis Paulus Bouten, Eindhoven (NL); Peter Jan Slikkerveer, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninkljke Philips Electronics N.V., Eindhoven (NL)

(21) Appl. No.: 10/531,215

(22) PCT Filed: Sep. 19, 2003
(86) PCT No.: PCT/IB03/04176

§ 371 Date: Apr. 13, 2005

(30) Foreign Application Priority Data
Oct. 16, 2002 (EP) 02079277.6

(51) Int. Cl. G02F 1/13; G09G 3/10

(52) U.S. Cl. 349/1; 315/169.3

(57) ABSTRACT

The present invention concerns substrates for a flexible flat panel display able The present invention concerns substrates for a flexible flat panel display (110) able to bent into a low radius of curvature, wherein the cell gap deviation is controlled and preferably minimised, even when the flexible flat panel display (110) is affected by pressure application or bending. According to a certain aspect there is provided composite substrates consisting of a substrate with a high Young's modulus and a substrate of low Young's modulus.

### FIELD OF INVENTION

The present invention relates to a flexible flat panel display such as a liquid crystal display (LCD), an organic light emitting diode display, a field emitting display, or a thin or thick film electro-chrome or electro-luminescence display. In particular, the invention relates to a flexible flat panel display able to bend into a radius of curvature. The present invention further relates to a flexible substrate for a flat panel display.

### BACKGROUND OF INVENTION

Flexible flat panel displays are at present in their development stages, however, an expanding market is envisaged in a wide variety of circumstances, where the flexible flat panel displays, in particular, experiences tensile, compressive and shear stresses while the functionality of the flat panel display is maintained. During manufacturing of panel displays, the flat panel displays are exposed to pressure loads for example during bonding of layers together, however, the flexibility of the flat panel displays ensures that the largest possible number of flat panel displays will work.

A flexible flat panel display has been described in earlier patent applications. For example British patent application no. GB 2 337 131 A describes a LCD and a manufacturing method for such, in which the LCD comprises two layers of substrates separated by wall-shaped spacers. The LCD is specifically designed so as to satisfy the condition qL⁴/Eh³≦π⁵V/48, where ‘q’ is applied pressure such as bonding pressure during manufacturing, ‘L’ is the distance between the wall-shaped spacers, ‘E’ is the modulus of elasticity of the substrate, ‘h’ is the thickness of the substrate, ‘V’ is the tolerable change in the thickness of the cell defined between the two layers of substrates and the wall-shaped spacers. The object for satisfying the above condition the LCD is according to the British patent application to manufacture a LCD element, which is capable of maintaining an even cell thickness (gap) during pressure applied normal to the substrate surface and providing a favourable display. Nevertheless, during a manufacturing process or during use of the LCD, the LCD may, in addition to be exposed to pressure, further be exposed to bending.

Furthermore, International patent application no. WO 02/43032 describes a flexible display device including a flexible substrate and a plurality of row and column electrodes attached to the substrate with a display material between the row electrodes and the column electrodes. The material for the substrate may be an inorganic glass or a polymer film. However, the flexible display device described in the International application utilises amorphous and semi-crystalline polymers, which are in their glass state at normal usage conditions of the displays.

In addition, the prior art does not satisfactorily provide a substrate suitable for a flexible flat panel display allowing a low radius of curvature, while maintaining a satisfactory display operation.

### SUMMARY OF THE INVENTION

An object of the present invention is to solve the problems encountered with the prior art as described above, problems relating to allowing flexibility of flat panel display element exposed to pressure and/or bending.

The above objects, together with numerous other objects, advantages and features, which will become evident from below detailed description, is obtained according to a first aspect of the present invention by a flexible flat panel display comprising a first substrate characterized in that the first substrate has a modulus of elasticity smaller than or equal to 1.5 GPa.

The first substrate according to the first aspect of the present may further have a modulus of elasticity smaller than or equal to a modulus selected among the group consisting of 1.3 GPa, 1.1 GPa, 1 GPa, 0.9 GPa, 0.8 GPa, 0.7 GPa, 0.6 GPa, 0.5 GPa, 0.4 GPa, 0.3 GPa, 0.2 GPa and 0.1 GPa. By utilising materials having a low modulus of elasticity a particular flexible flat panel display may be achieved.

The first substrate may be fabricated from any polymer film in its rubber state during normal working conditions for a typical flat panel display. That is, a material having a glass transition temperature below the normal working conditions for a typical flat panel display, e.g. below 80° C., below 60° C., below 40° C., below 30° C., below 0° C., below −20° C. below −40° C.

Further, the first substrate may be fabricated from any rubbers or rubber-like polymers for example based on silicone, urethane, neoprene, butyl rubber, ethene-propene rubber, acrylate rubber, butadiene rubber, choloprene rubber, nitrile rubber, 1-1 propene rubber, flouridised rubber, styrene-butadiene, natural rubber or any combination thereof.

The flat panel display may comprise an electro-optical medium such as liquid crystal, or an electro-chrome or electro-phoretic element, a light emitting element, an organic or inorganic light emitting element, polymer light emitting element, or any combination thereof. Any type of electro-optical medium may be used in the flat panel display without the material properties are compromised thus ensuring the flexibility in a flat panel display using any type of electro-optical medium. In fact, even plasma may be used as the electro-optical medium.

The flexible flat panel display according to the first aspect of the present invention may further comprise one or more layers positioned substantially coplanar and adjacent to upper and/or lower surface of the first substrate. The layers may have a high modulus of elasticity, that is, having a modulus of elasticity greater than 1.5 GPa. Alternatively, the layers may have a low modulus of elasticity, that is, a modulus of elasticity lower equal to or smaller than 1.5 GPa. The layers may provide a coating to the first substrate and have a thickness up to 80% of the total thickness of the first substrate and the additional layers added to the first substrate.

Further, the flat panel display may comprise a display substrate positioned coplanar with the first substrate, which display substrate may have a modulus of elasticity smaller than or equal to 1.5 GPa. The flat panel display may in fact comprise one or more layers positioned substantially coplanar and adjacent to upper and/or lower surface of said display substrate.

The term upper and lower surface of the first substrate should in this context be construed a first and second surface, which in context with is to be construed as the larger surfaces of the first substrate or the display substrate.

The display substrate according to the first aspect of the present may further have a modulus of elasticity smaller than or equal to a modulus selected among the group consisting of 1.3 GPa, 1.1 GPa, 1 GPa, 0.9 GPa, 0.8 GPa, 0.7 GPa, 0.6 GPa, 0.5 GPa, 0.4 GPa, 0.3 GPa, 0.2 GPa and 0.1 GPa.

The flexible flat panel display according to the first aspect of the present invention may further comprise a first spacer and a second spacer positioned between the first substrate and the display substrate, and a cell structure for containing the electro-optical medium and defined between the first substrate, the display substrate, the first spacer, and the second spacer. The cell structure may define a cell gap between the first substrate and the display substrate.

The flexible flat panel display according to the first aspect of the present invention may further comprise a first layer positioned substantially coplanar and adjacent to the first substrate, which first layer may have a modulus of elasticity, E_{I}, and which may have a thickness of up to 80% of the total thickness of the first substrate and the first layer, and the first substrate may have a modulus of elasticity, E_{II}, where E_{I} is larger than E_{II}.

In addition, the flexible flat panel display according to the first aspect of the present invention may comprise a second layer positioned substantially coplanar and adjacent to the display substrate, which second layer may have a modulus of elasticity, E_{III}, and which may have a thickness of up to 80% of the total thickness of the display substrate and the second layer, and the display substrate may have a modulus of elasticity, E_{IV}, where E_{III} is larger than E_{IV}. By establishing a composition of layers and substrates a particularly advantageous flat panel display is achieved since this increases bending flexibility of flat panel displays manufactured according to known procedures. By for example coating a liquid crystal display with a rubber foil on the outer surfaces of the first layer and/or second layer the cell gap variation's sensitivity to bending may be significantly reduced. Addition of the extra (=soft) layer significantly improves the bending (in)sensitivity and only slightly affects the bending flexibility.

The ratio E_{I}/E_{II} and/or the ratio E_{III}/E_{IV} may be larger than a number chosen among 2, 2.5, 3, 5, 8, 10, 15 or 20. The first layer and the second layer may be positioned nearest the electro-optical medium and the first substrate and the display substrate may be positioned furthest from the electro-optical medium. Since tensile strain in a bent flexible flat panel display is largest at the outermost surfaces the design of the flexible flat panel display should ensure that the modulus of elasticity is lowest at the outermost surfaces. The flexibility of the flexible flat panel display and the stresses particularly on the seal are reduced by the first substrate and the display substrate having a lower modulus of elasticity.

The flexible flat panel display according to the first aspect of the present invention may be adapted to bend into a curvature, while ensuring a relative variation of the cell gap, Δ/d, equal to or smaller than 5%. The flexible flat panel display satisfies the expression:

$$Δ / d \leq \frac{( \frac{1}{d} + \frac{1}{h} ) {L}^{4}}{{κ}_{Geo} {R}^{2} h}$$

where d is the cell gap, h is thickness of the first or the second substrates, L is the distance between the first and second spacers, κ_{Geo} is a geometric constant, and R is radius of the curvature of the flat panel display while bent.

The geometric constant, κ_{Geo}, may equal a value in the range 1 to 64, such as for example κ_{Geo} equal to 32 when the flat panel display has symmetrical first and second substrates. The value is dependent on the geometrical shape of the flat panel display.

When d<<h then the expression may be reduced to:

$$Δ \leq \frac{{L}^{4}}{{κ}_{Geo} {R}^{2} h} \qquad [ 2 ]$$

where Δ is the actual cell gap variation.

It is a further object of the present invention to ensure a cell thickness (gap) control so as to reduce the cell gap deviation caused by in-homogeneities and/or bending to lesser 5% over each cell pitch. The term cell pitch is in this context to be construed as the distance between the spacers, or the span length between the spacers.

The relative cell gap variation according to the first aspect of the present invention may be equal to or smaller than a relative cell gap variation selected among the group consisting of 5%, 4%, 3%, 2.5%, 2%, 1.5%, 1%, 0.5%, 0.25% and 0.1%. The smaller the cell gap variation the better is the overall quality of the liquid crystal display and in particular the overall quality of the information displayed on the liquid crystal display.

The first substrate and/or the display substrate according to the first aspect of the present invention may comprise a flexible polymer being transparent or opaque. Polymer failure should preferably be avoided thus the first substrate and/or display substrate with lower modulus provides for a high failure strain, as opposed to substrates with higher modulus, giving a low failure strain.

The substrate according to the first aspect of the present invention may be bendable into a radius of curvature smaller than a radius selected among the group consisting of 300, 200, 100, 50, 40, 30, 20, 15, 10, 5, 3 and 1 mm. Selecting the first substrate and/or display substrate having low modulus of elasticity provides for a flexible flat panel display being bendable into a small radius of curvature. Therefore in case a larger radius of curvature is a design criteria then the choice of materials for the first substrate and/or the display substrates may be selected having higher modulus of elasticity. Selecting a material with low modulus of elasticity may provide for a flexible flat panel display with reduced shear loading on the seal line of the flexible flat panel display cells, and a lowered risk of failure of the cells.

The provision of a bendable substrate ensures that for example a flexible flat panel display maybe folded around a wide variety of objects thus increasing the usability of flat panel displays. In fact the bendable substrate may be used for carrying electronic circuitry for any handheld and mobile devices and thus provide a unique possibility of improving the utilisation of space in such devices.

The flexible flat panel display according to the first aspect of the present invention may further comprise a plurality of first and second spacers between the first substrate and the display substrates defining a plurality of cell structures there between.

The above objects, together with numerous other objects, advantages and features, which will become evident from below detailed description, is obtained according to a second aspect of the present invention by a flexible substrate characterised in having a modulus of elasticity smaller than or equal to 1.5 GPa.

The flexible substrate according to the second aspect of the present invention may incorporate any features described with reference to the first aspect of the present invention.

The above objects, together with numerous other objects, advantages and features, which will become evident from below detailed description, is obtained according to a third aspect of the present invention by a method for manufacturing a flat panel display, which method may comprise adding a first and second layers to a regid flat panel display, the first and second layers having a low modulus of elasticity such as rubber foil. Alternatively, the method may comprise providing a first and second layer in coplanar relationship, adding spacers between the first and second layer so as to define there between a cell structure for receiving a electro-optical medium, adding a additional layers positioned substantially coplanar and adjacent to the outermost surfaces of the first and second layers and having a modulus of elasticity smaller than the first and second layers.

The method for manufacturing a flexible flat panel display according to the third aspect of the present invention may incorporate any features described with reference to the first and second aspect of the present invention.

### BRIEF DESCRIPTION OF THE DRAWINGS

The above, as well as additional features and advantages of the present invention, will be better understood through the following illustrative and non-limiting detailed description of preferred embodiments of the present invention, with reference to the appended drawings, wherein:

FIG. 1, shows a schematic representation of a cross section of a substrate;

FIG. 2, shows a graph of critical values for height as a function of wall-separation (pitch) for a bi-layer cell with substrates with equal parameters; and

FIG. 3, shows a schematic representation of a cross section of a part of a flexible LCD.

### DETAILED DESCRIPTION OF PREFERRED EMBODIMENTS

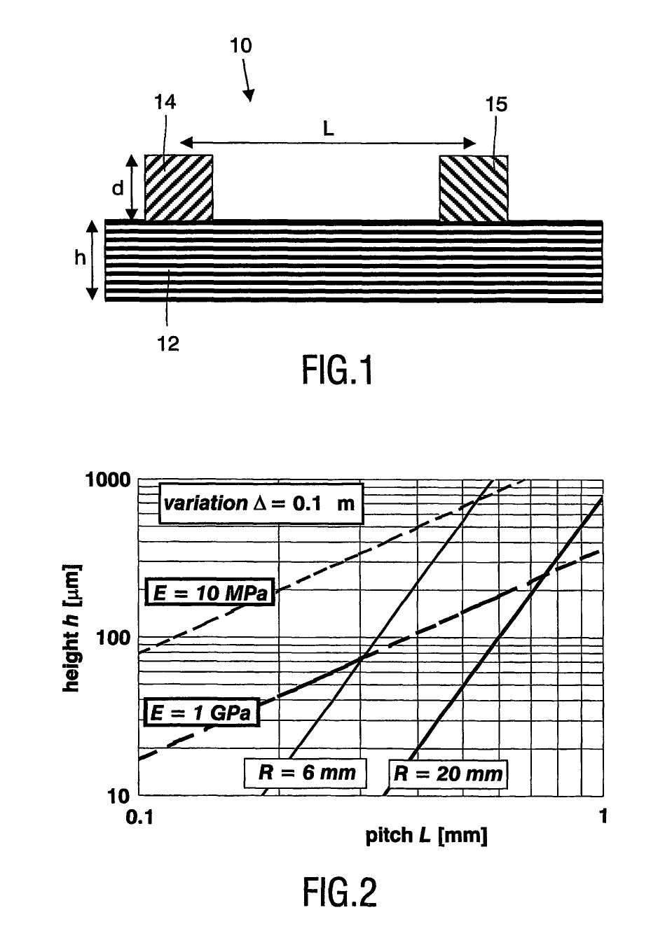

FIG. 1 is a schematic representation, 10, showing a cross section of a first substrate, 12, carrying two spacers, 14 and 15. The figure is not to scale. The parameters L, d and h are indicated in the figure. L is the span length, i.e. the distance between the middle of the spacers. d is the initial cell gap, and h is the thickness of the substrate.

FIG. 2 depicts critical values for height as a function of pitch, for a bi-layer cell with equal parameters, where Δ=0,1 μm. The solid lines are calculated for bent cells fixed R, while the broken lines are calculated for flat cells at constant applied pressure q and fixed E. The working area for proper functioning upon both pressure application and bending in this figure is the upper left corner.

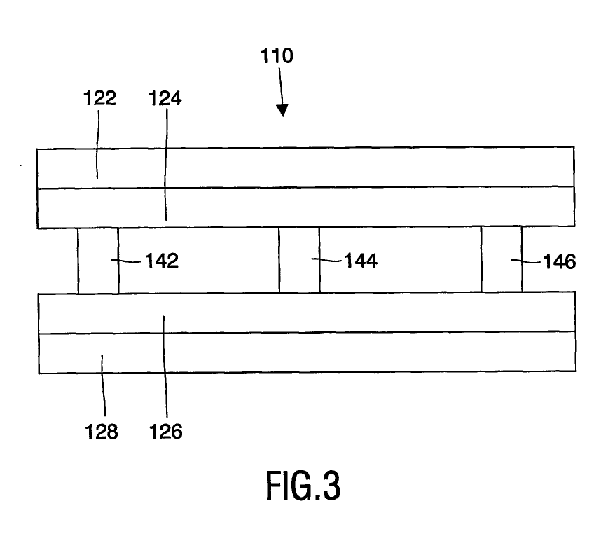

FIG. 3 is a schematic representation of a cross section of a part of a flexible LCD, 110, according to the present invention. The figure is not to scale. The flexible LCD, 110, comprises a first substrate 122 and a first layer 124, and a display substrate 128 and a second layer 126. The first layer 124 and second layer 126 are separated by a number of spacers, 142, 144 and 146. The first layer 124 has a modulus of elasticity larger than the first substrate 122, and the second layer 126 has a modulus of elasticity larger than the display substrate 128.

### EXAMPLES

### Example 1

The spacer pitch in a matrix addressed flexible LCD display is preferably chosen in accordance with the pixel pitch. The cell gap variation upon bending depends on substrate height and spacer pitch (equation 1). In the present example an allowed cell gap change Δ=0.1 mm is assumed for the working display. For 150 mm thick substrates and spacer pitch L=500 μm a minimum bending radius R=11.4 mm is obtained. At this radius the maximum strain in the substrate is 1.3%.

The use of a high modulus substrate (E=2000 MPa) is compared with a low modulus substrate (E=100 MPa).

At a critical elongation the substrate behaves no longer elastically, either by onset to plastic deformation or due to mechanical failure. The critical elongation for high modulus materials is in general in the order of 1%, while for low modulus materials it is above 10%.

The critical deformation limit (1%) of the LCD display with high modulus substrates is achieved at R=15 mm. For the limit for the low modulus substrate (10%) is achieved at R=1.5 mm.

At equal curvature the stresses in the display with low modulus substrates are significantly lower (the ratio of the moduli of the substrates, in this example a factor 20). This reduces the risk of failure of for instance the peripheral seal line.

With low modulus substrates significantly lower bending radii can be achieved. The failure risk of displays or display elements, like substrates or seal, is strongly reduced.

### Example 2

An LCD is made with high modulus (E=2000 MPa) thin (h=50 mP) substrates. The spacer distance in the cell L=500 μm. For proper cell gap control, Δ<0.1 μm is required. Then the limiting bending radius R=20 mm.

To achieve a better bending performance a second layer (150 □m, low modulus; E=100 MPa), is added to both display surfaces. With this added layer a significantly better bending performance is obtained. Proper cell gap control (Δd<0.1 μm) is achieved down to a bending radius R=9 mm.

In the present cell geometry, optical layers like a polarizer and retarder, may be integrated in the high modulus substrate.

The addition of (a) soft layer(s) to the substrate improves the cell performance upon bending.

### Example 3

Handling of these thin foils is a tedious job. Wrinkling may damage the thin substrates; the local stresses at the wrinkles are above the allowed strain.

As an example an electro-luminescent display (OLED) will be used. The display is made on a thin, high modulus, polymer substrate (E=3000 MPa, h=30 μm). The actual display structure has a limited thickness (<4 μm) on top of the substrate; it includes all functional layers, also (brittle) hermetic coatings. A low modulus layer is applied on top of the display structure (E=100 MPa, h=200 mm). The addition at least one low modulus layer to the thin substrate retards the wrinkle formation.

A number of layers in the display, such as the brittle hermetic coating, fail above a critical strain. With a critical strain of 0.5%, the 30 μm thick substrate can be rolled to a radius of 3 mm. With the addition of the low modulus layer on the outer surface (of the rolled display) even a lower bending radius can be achieved.

1. A flexible flat panel display comprising a first substrate characterized in that said first substrate has a modulus of elasticity smaller than or equal to 1.5 GPa.

2. A flexible flat panel display according to claim 1, wherein said first substrate has a modulus of elasticity smaller than or equal to a modulus selected among the group consisting of 1.3 GPa, 1.1 GPa, 1 GPa, 0.9 GPa, 0.8 GPa, 0.7 GPa, 0.6 GPa, 0.5 GPa, 0.4 GPa, 0.3 GPa, 0.2 GPa and 0.1 GPa.

3. A flexible flat panel display according to claim 1, wherein said flat panel display comprises an electro-optical medium such as a liquid crystal, or an electro-chrome or electro-phoretic element, a light emitting element, an organic or inorganic light emitting element, polymer light emitting element, or any combination thereof.

4. A flexible flat panel display according to claim 1 further comprising one or more layers positioned substantially coplanar and adjacent to upper and/or lower surface of said first substrate.

5. A flexible flat panel display according to claim 1 further comprising a first layer positioned substantially coplanar and adjacent to said first substrate, which first layer has a modulus of elasticity, E_{I}, and said first substrate has a modulus of elasticity, E_{II}, where is E_{I} larger than E_{II}.

6. A flexible flat panel display according to claim 5, wherein said first layer is positioned nearest said electro-optical medium and said first substrate furthest from said eletro-optical medium.

7. A flexible flat panel display according to claim 5, wherein the ratio E_{I}/E_{II} is larger than a number chosen among the group of numbers 2, 2.5, 3, 5, 8, 10, 15 or 20.

8. A flexible flat panel display according to claim 5, wherein said first layer has a thickness of up to 80% of the total thickness of said first substrate and said first layer.

9. A flexible flat panel display according to claim 1, wherein said first substrate is bendable into a radius of curvature smaller than a radius selected among the group consisting of 300, 200, 100, 50, 40, 30, 20, 15, 10, 5, 3 and 1 mm.

10. A flexible flat panel display according to claim 1 further comprising a display substrate positioned coplanar with said first substrate, which display substrate has a modulus of elasticity smaller than or equal to 1.5 GPa.

11. A flexible flat panel display according to claim 10, wherein said display substrate has a modulus of elasticity smaller than or equal to a modulus selected among the group consisting of 1.3 GPa, 1.1 GPa, 1 GPa, 0.9 GPa, 0.8 GPa, 0.7 GPa, 0.6 GPa, 0.5 GPa, 0.4 GPa, 0.3 GPa, 0.2 GPa and 0.1 GPa.

12. A flexible flat panel display according to claim 10 further comprising one or more layers positioned substantially coplanar and adjacent to upper and/or lower surface of said display substrate.

13. A flexible flat panel display according to claim 10 further comprising a second layer positioned substantially coplanar and adjacent to the display substrate, which second layer has modulus of elasticity, E_{III}, and said display substrate has a modulus of elasticity, E_{IV}, where said E_{III} is larger than E_{IV}.

14. A flexible flat panel display according to claim 13, wherein the ratio E_{III}/E_{IV} is larger than a number chosen among the group of numbers 2, 2.5, 3, 5,8, 10, 15 or 20.

15. A flexible flat panel display according to claim 13, wherein said second layer has a thickness of up to 80% of the total thickness of said display substrate and the second layer.

16. A flexible flat panel display according to claim 10 further comprising a first spacer and a second spacer positioned between said first substrate and said display substrate, and a cell structure for containing said electro-optical medium and defined between said first substrate, said display substrate, said first spacer and said second spacer, said cell structure defining a cell gap between said first substrate and display substrate.

17. A flexible flat panel display according to claim 16, wherein said second layer is positioned nearest said electro-optical medium and said display substrate is positioned furthest from said eletro-optical medium.

18. A flexible flat panel display according to claim 16, wherein said flexible flat panel display being adapted to bend into a curvature, while ensuring a relative variation of said cell gap, Δ/d, equal to or smaller than 5%.

19. A flexible flat panel display according to claim 16, wherein said flexible flat panel display satisfies the expression:
$$Δ / d \leq \frac{( \frac{1}{d} + \frac{1}{h} ) {L}^{4}}{{κ}_{Geo} {R}^{2} h}$$
where d is said cell gap, h is thickness of said first or said second substrate, L is the distance between said first and second spacers, κ_{Geo} is a geometric constant, and R is radius of curvature of said flat panel display while bent.

20. A flexible flat panel display according to claim 16, wherein said relative cell gap variation is equal to or smaller than a relative cell gap variation selected among the group consisting of 5%, 4%, 3%, 2.5%, 2%, 1.5%, 1%, 0.5%, 0.25% and 0.1%.

21. A flexible flat panel display according to claim 10 further comprising a plurality of first and second spacers positioned between said first and second substrates defining a plurality of cell structures there between.

22. A flexible flat panel display according to claim 1, wherein said first substrate comprises a flexible polymer being transparent or opaque.

23. A flexible flat panel display according to claim 10, wherein said display substrate comprise a flexible polymer being transparent or opaque.

24. A flexible substrate characterised in having a modulus of elasticity smaller than or equal to 1.5 GPa.

25. A flexible substrate according to claim 24, wherein said substrate incorporates any features of the flexible flat panel display according to claim 1.
